(19) United States
(12) Patent Application Publication
(10) Pub. No.: US 2005/0120101 A1
(43) Pub. Date: Jun. 2, 2005

(54) Apparatus, method and article of manufacture for managing changes on a compute infrastructure

(76) Inventor: David Nocera, Martinsville, NJ (US)

Correspondence Address: GOODWIN PROCTER L.L.P, 103 EISENHOWER PARKWAY, ROSELAND, NJ, 07068, US

(21) Appl. No.: 10/480,566

(22) PCT Filed: Jun. 11, 2002
(86) PCT No.: PCT/US02/18473

Related U.S. Application Data
(60) Provisional application No. 60/297,512, filed on Jun. 11, 2001.

(51) Int. Cl. G06F 15/173

(52) U.S. Cl. 709/223; 709/224

(57) ABSTRACT

Provided herein is a system and method for detecting unauthorized and accidental changes to a compute infrastructure. In an exemplary embodiment of the present invention, the system comprises: Manager Nodes (e.g., Managers, Managers with Gateways), Gateways, and Managed Nodes (e.g., Managed Nodes with Agents, Agentless Managed Nodes, Managed Software Components, such as application software, and Managed Special Devices). Agents are comprised of multiple Simple or Dynamic Beans that are used to manage list of Attributes. Simple Beans manage fixed lists of Attributes and Dynamic Beans manage variable lists of Attributes. The system provides for specialized reporting of unauthorized or accidental changes to the compute infrastructure by, among other things, enabling the Attributes to be reported as a single attribute and/or as a group of attributes.

### CROSS REFERENCE TO RELATED APPLICATION(S)/CLAIM OF PRIORITY

This application is a national phase application of International Application No. PCT/US02/18473, filed on Jun. 11, 2002.

### STATEMENT REGARDING FEDERALLY SPONSORED RESEARCH OR DEVELOPMENT

Not applicable.

### REFERENCE OF AN APPENDIX

Not applicable.

### FIELD OF THE INVENTION

The present invention relates generally to compute and/or network management and more particularly to an improved system, method, apparatus, and article of manufacture for managing changes on a compute infrastructure.

### BACKGROUND OF THE INVENTION

Heretofore, compute infrastructure change management techniques involve methodologies that publicize the change before it occurs so that all potential impacts can be understood and appropriate sign-off achieved. However, the foregoing methodologies are often time-consuming and cumbersome. Additionally, organizations that implement a formal change process are often plagued by unauthorized or accidental changes bundled with authorized changes wherein the unauthorized or even accidental changes are not handled.

Accordingly, what is needed is a solution that detects unauthorized and accidental changes on a compute infrastructure and further allows such changes to be minimized by exposing variability with unique data visualization techniques thereby allowing that variability to be minimized or eliminated altogether.

### SUMMARY OF THE INVENTION

The present solution addresses the aforementioned problems of the prior art by providing for, among other things, an improved apparatus, method and article of manufacture for managing changes on a compute infrastructure, one that simplifies the complexity of that compute infrastructure by providing a means to reduce the variability of configuration settings, audit those settings and thereby reduce change.

Therefore, in accordance with one aspect of the present invention and further described in the Reporting and Grouping section, there is provided at least one exemplary approach for grouping of nodes and attributes in order to manage changes on an exemplary compute infrastructure.

In accordance with a second aspect of present invention and further described in the Multi-Line Configuration section, there is provided at least one exemplary approach for reporting multiple attributes as a single attribute at a high-level using a value such as a checksum or digital signature to summarize the values of the multiple lines into a single value. A user can then drill-down to the change details.

In accordance with a third aspect of the present invention and further described in the Database Updates section, there is provided at least one exemplary approach for using change notification events to keep multiple database tables synchronized with a source copy.

In accordance with a fourth aspect of the present invention and further described in the Dynamic and Control Bean Pairs section, there is provided at least one exemplary approach for using dual Beans, one as a Dynamic Bean and a second as a Control Bean, to manage the attributes and configuration of the Dynamic Bean.

In accordance with a fifth aspect of the present invention and further described in the Attribute Test section, there is provided at least one exemplary approach for using commands as a means for populating the values associated with attributes, the commands being executed using the Simple or Dynamic Bean. The commands can be internal Java commands, methods or functions, an external system, application utilities or interactive programs. The commands can be executed on any node and the results stored into a relational database schema.

In accordance with a sixth aspect of the present invention and further described in the Extending Java/JMX section, there is provided a bridge between a Java program and system or application utility or interactive command, including the use of pipes to connect Java to non-Java application commands, including interactive commands.

In accordance with a seventh aspect of the present invention and further described in the Gateways section, there is provided at least one exemplary approach for using Java/JMX to manage an agentless node and how to extend Java/JMX as a tunnel through a Firewall.

In accordance with an eighth aspect of the present invention and further described in the New Data Warehouse Architecture section, there is provided at least one exemplary approach for building a corporate data warehouse architecture leveraging an Archive Object. The new data warehouse model does not store data centrally; rather it uses the Archive Object at Managed Nodes or Gateways to store data. This avoids the purchase of a large centralized data warehouse node, and takes advantages of previously untapped resources (CPU, Disk and Memory) on corporate Managed Nodes to perform the data warehouse function. At the time of this invention, most large computers ran at 30% CPU busy with excess disk, memory and network bandwidth resources.

In accordance with a ninth aspect of the present invention, change can be detected and nodes can be synchronized to a baseline. The one-to-many node comparison allows multiple nodes to be synchronized to a master baseline or another node. This provides the tools to reduce the complexity of compute infrastructure by reducing variability of product or node configurations.

In accordance with a tenth aspect of the present invention, the scope of attributes are defined in a manner that facilitates the easy comparison of results to multiple nodes, so that the results within a scope type can be filtered. This further improves the node comparison reporting, by providing a finder degree of control of the displayed results.

In accordance with an eleventh aspect of the present invention, a unique configuration of agent Mbeans is disclosed, one that uses a set of Mbeans (as Control is and Attribute pairs) to manage both agent and agentless connectivity.

In accordance with the twelfth aspect of the present invention, the detection of change by the disclosed framework can cause other events to occur, such as the update of a database table with the newly changed data, or the execution of another attribute test, alert or email.

These and other aspects, features and advantages of the present invention will become better understood with regard to the following description and accompanying drawings.

### BRIEF DESCRIPTION OF THE DRAWINGS

Referring briefly to the drawings, embodiments of the present invention will be described with reference to the accompanying drawings in which:

FIG. 1 illustrates a first aspect of the present invention.

FIG. 2 illustrates a second aspect of the present invention.

FIG. 3 illustrates a third aspect of the present invention

FIG. 4 illustrates a fourth aspect of the present invention

FIG. 5 illustrates a fifth aspect of the present invention

FIG. 6 illustrates a sixth aspect of the present invention

FIG. 7 illustrates a seventh aspect of the present invention

FIG. 8 illustrates an eighth aspect of the present invention

FIG. 9 illustrates a ninth aspect of the present invention

FIG. 10 illustrates a tenth aspect of the present invention

FIG. 11 illustrates an eleventh aspect of the present invention

FIG. 12 illustrates a twelfth aspect of the present invention.

### DETAILED DESCRIPTION OF THE INVENTION

Referring more specifically to the drawings, for illustrative purposes the present invention is embodied in the system configuration, method of operation and article of manufacture or product, generally shown in FIGS. 1-12. It will be appreciated that the system, method of operation and article of manufacture may vary as to the details of its configuration and operation without departing from the basic concepts disclosed herein. The following description, which follows with reference to certain embodiments herein is, therefore, not to be taken in a limiting sense.

### High Level Description

FIG. 1 illustrates the overall architecture of this invention consisting of Managers (FIG. 1—1.0, 2.0, 2.1, 2.2), Managers with Gateways (FIG. 1—3.0), Gateways (FIG. 1—4.0), Managed Nodes with Agents (FIG. 1—5.1, 5.2, 5.3 etc), Managed Nodes that are Agentless, Agentless Manged Nodes are managed with a Gateway agent configuration, which can run both on the Manger node itself, or on separate node in a Gateway configuration, (FIG. 1—6.0, 6.1, 6.2 etc), Software including application software, that can be managed like a node,software that encapulates the management of multiple nodes (e.g. Element Managers, HP Open View, BMC Patrol etc) can be viewed and managed as a single node in this architecture, (FIG. 1—7.0, 7.1 etc.), and Special Devices that can be managed, any device or specialized software that can be managed from the network, can be managed using this system and method., (FIG. 1—8.0, 8. 1, etc).

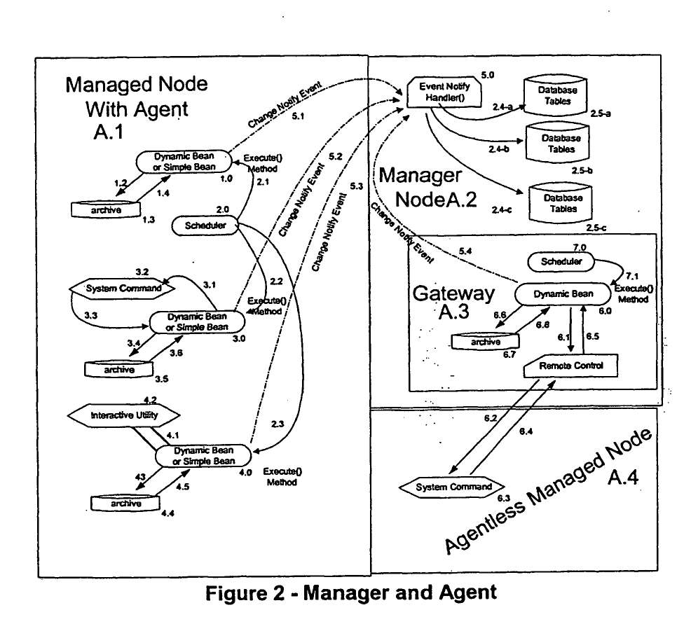

Agents can be configured (FIG. 2—A.1) on Managed Nodes, Gateways (FIG. 2—A.3) can be configured to allow Agentless configurations (FIG.—A.4) with Managed Nodes that have no Agent software installed. Agentless Managed Nodes are nodes that the present invention can manage without the need to install specialized agent software on the Managed Node. Java JMX does not disclose that certain adapters (such as the SNMP or HTTP adapter) to manage non-JMX applications, Java JMX does not disclose that certain adaptors need to be able to execute system or application utilities or even interactive utilities. This system and method can be used to extend the Java JMX adapter concept to a more robust set of JMX adapters, adapting to any system or application utility or interactive program. For example, a router or storage area network switch may be managed as agentless devices. It accomplishes this agentless connection using a configuration of an Agent, which is illustrated in this example as a Gateway (FIG. 1 3.0, 4.0-FIG. 2 A.3). The Gateway can run on dedicated Gateway nodes (FIG. 1—4.0), independent from the Managers, or the Gateway functionality can run on a Manager node (FIG. 1—3.0).

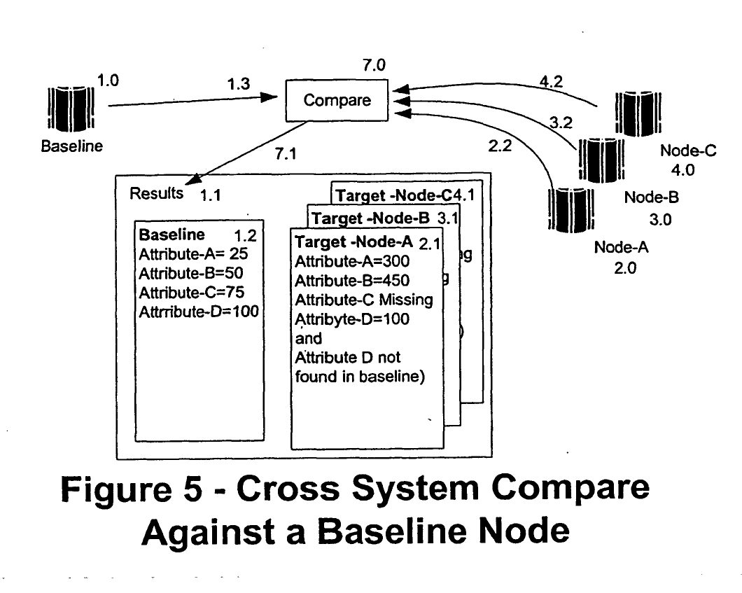

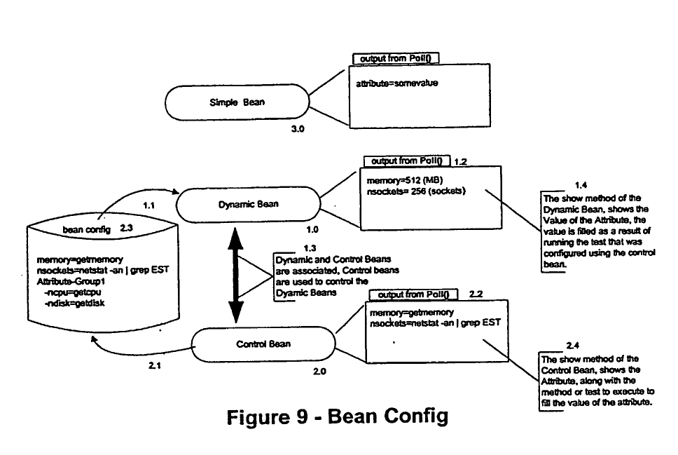

Agents are comprised of multiple Simple or Dynamic Beans (FIG. 2—1.0, 3.0, 4.0 and 6.0). Simple and Dynamic Beans are used to manage list of Attributes (FIG. 5—2.x, 3.x and 4.x). Simple Beans manage (FIG. 9—3.0) fixed lists of Attributes and Dynamic Beans (FIG. 9—1.0) manage variable lists, which are configured via a Control Bean (FIG. 9—2.0).

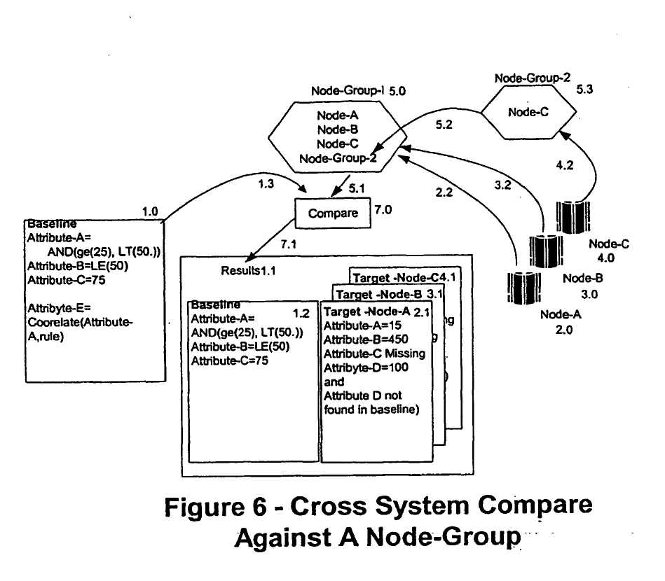

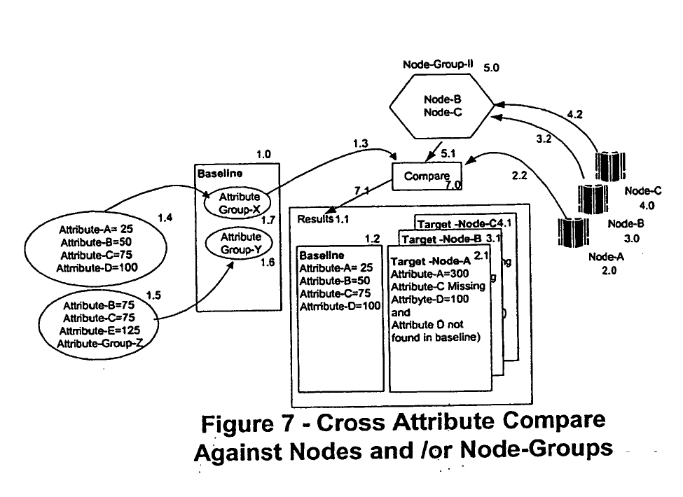

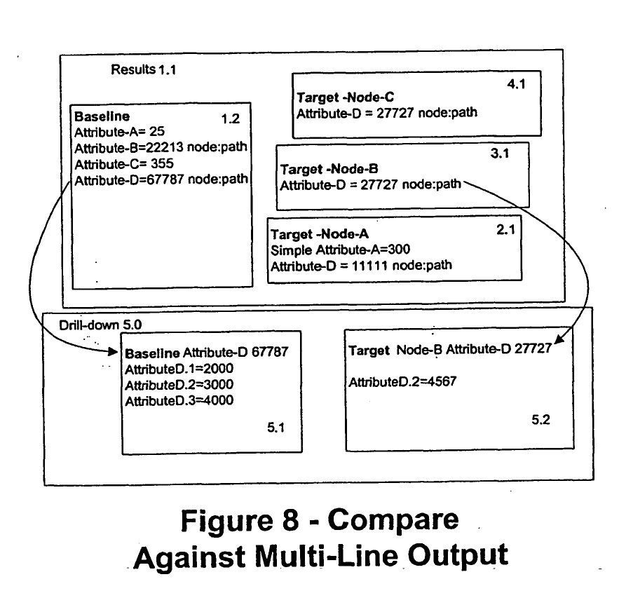

Attributes in a Dynamic Bean can be grouped at the Managed Node (FIG. 9—2.3 Attribute-Group1) to be reported as a single attribute, or each attribute can be reported independently. Attributes can also be grouped at the Managers (FIG. 7—1.x), also for reporting and display purposes. Nodes can also be grouped at the Managers (FIG. 6—5.0 & 5.3). These options allow specialized reporting and display of changes to a compute infrastructure (FIG. 5—1.1, FIG. 6—1.1, FIG. 7—1.1) fully configurable by the users. In some cases, whereby multi-line changes are detected, a checksum or digital signature is used to summarize multiple lines of output into a single value (FIG. 8—3.1). The specific attributes can be displayed using drill-down capabilities (FIG. 8—5.0). When using drill-down, the datafile containing the differences may be stored at the Managed Node, at the Manager, or the differences can be computed during drill-down time, whereby the original source is stored at the Managed Node or at the Manger. FIG. 8—2.1 “node:path” is intended to indicate that the location of the differences if both flexible and varied. These reports and displays are derived from the Manager Node's (FIG. 2—A.2) database tables (FIG. 2—2.5.a, 2.5b & 2.5c).

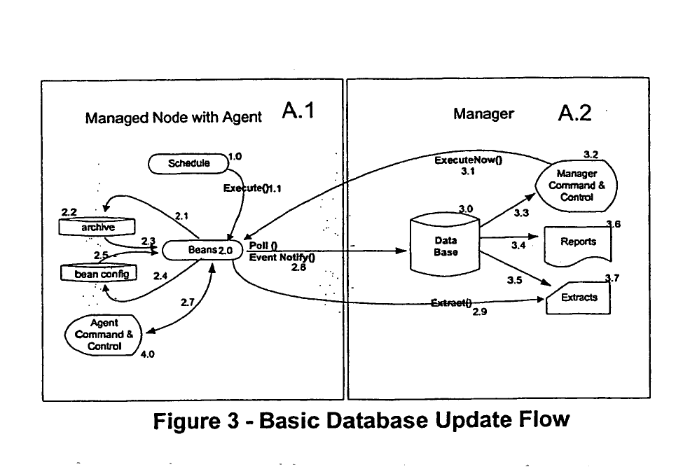

Node specific configuration and reporting can be performed on the Managed Node via an Agent's command and control interface (FIG. 3—4.0). Enterprise wide configurations and reporting, as well as node specific is done from a Manager's command and control interface (FIG. 3—3.2).

Functionality is distributed using Beans. Simple Beans are “hard-coded” for specific tasks and contain fixed attributes. The more comprehensive Dynamic Bean functionality is usually distributed in pairs, whereby a Control Bean is used to manage a Dynamic Bean (FIG. 9). Dynamic and Control Bean functionality can be in the same Bean, this creates a hybid between the Simple and Dynamic Bean. In actuality this is still a Dynamic, which combines the finctionality of control into the Bean. The Control Bean specifies the names of the Attributes and particular tests that the Dynamic Bean will execute. The Control Bean does not run a selected test, it is used to configure the test that the Dynamic Bean will run. A Simple Bean has a fixed list of tests, which are not configurable, so it does not require a Control Bean. The Dynamic Bean executes a test and fills in the value for an attribute, to be returned to the Manager(s) via a Notify event (FIG. 2—5.1, 5.2, 5.3 & 5.4) as changed values to attributes. The Poll( ) method of the Dynamic Bean can also be called by the Manager, for example, to synchronize an associated database with the latest values for attributes (FIG. 9—1.2). Using Poll( ) against the Dynamic Bean, the database is initially configured with correct names and values for attributes and/or maintained current after an outage of one or more nodes. Using the Notify( ) mechanism, only changes are transmitted to the Managers.

### Agent

Beans

Beans are independent pieces of code that are used to perform useful work. Beans run within the Agent, which is connected to one or more Managers. The present solution contains multiple agents, that is, agents are containers of Beans. A Bean is an independent worker that runs on behalf of one or more attributes. Beans are deployed independently or in pairs. When deployed in pairs, a Control and Dynamic Bean work together to support maintaining a list of attributes for Manager(s) (FIG. 9). A Scheduler (FIG. 2 2.0,7.0) is a special purpose Bean that schedules tests for the Dynamic Beans (FIG. 2 2.0, 3.0, 4.0 and 6.0).

Dynamic and Control Bean Pairs

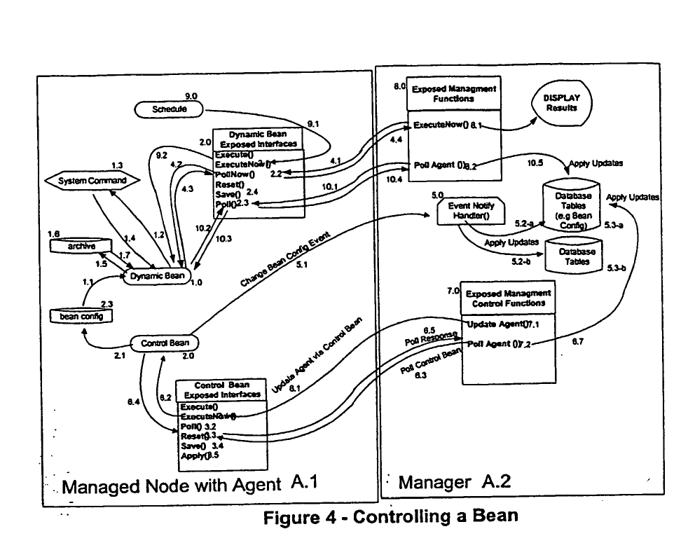

When deployed in pairs, a Control Bean is used to manage a Dynamic Bean. FIG. 9 illustrates the relationship. The functionality of the control Bean and dynamic Bean need not be deployed as a separate Beans. A Manager will update the Control Bean with a list of attributes and tests. In FIG. 9—2.3, 1.2 and 2.2, the name memory and nsockets are examples of attributes. Tests are the values specified by the Manager to the control Bean (FIG. 9—2.2). The test value examples in FIG. 9 are “getmemory” and “netstat -an | grep EST”. When the Control Bean is updated by the Manager, it writes the name of the attribute and test to a Bean config file (FIG. 9—2.3). The value fields in the Bean config file are the actual tests that the Dynamic Bean will execute in order to derive values for attributes. For example, when the Dynamic Bean runs the “netstat -an | grep EST” command it fills the value of nsockets with number of opened socket connections on the Managed Node. The Manager receives the values of attributes from the Dynamic Bean in multiple ways (e.g. Pollo method specified in FIG. 9—1.2), and sets the names of the tests to the Control Bean. When the Manager invokes the Pollo method of the Control Bean (FIG. 9—2.2) it sees the value of the attributes as the tests that the Dynamic Bean is configured to execute. When the Dynamic Bean is instantiated (starts), or when it receives a reset( ) via its exposed interfaces (FIG. 4—9.1), it re-reads and applies the Bean config settings in a in-core control list. When the Manager performs an ExecuteNowo or Scheduler an Execute( ) against the Dynamic Bean, for each attribute specified, the test configured in the in-core control list is executed and the value of the attribute filled in the Dynamic Bean. If at anytime, the Poll( ) method of the Dynamic Bean is executed, it returns the latest attribute values. A pollNow( ) method can actually update the latest values by running each test, similar to the ExecuteNow( ) method, but it executes all attribute tests. If at anytime the Dynamic Bean detects a change, while executing a test, it generates a Notify event to the Managers (FIG. 2—5.1, 5.2, 5.3, 5.4), who update the database. If at any time the Manager (FIG. 3—3.2) or the Agent (FIG. 3—4.0) command and control interface updates a Control Bean configuration, the Control Bean generates a Notify( ) event to the Managers to update the database. Note that for data stored or owned by the Managed Node, the database us updated using this Notify( ) event mechanism. This allows changes made at one Manager to be synchronized to all Managers registered to. receive events from the Managed Node or Gateway. The same holds true for Simple Beans.

Bean Interfaces

Simple Beans expose fixed attributes to the Manager and a subset of interfaces exposed by the Dynamic Bean. Specialized Simple or Dynamic Beans can expose additional interfaces. Dynamic Beans (FIG. 4—1.) execute tests or functions that were configured via the Control Bean (FIG. 4—2.0). These tests and all Beans can be controlled via several exposed interface, new Interface Functions can be added to the Beans (Both Control and Dynamic Beans) to the Dynamic Bean. Exposed interfaces include (FIG. 4) but are not limited to:

a) Execute( )—Which is passed an attribute name and runs the test that is associated with that name. Execute( ) (FIG. 2—2.1) will determine if a change has occurred. It does that by comparing the results of the test against the archive (FIG. 2—1.3) and will generate a Notify( ) (FIG. 2—5.1) event to the Manager(s) if a change has occurred.

b) ExecuteNow( )—Which is passed an attribute name, executes the test and returns to the caller the results of the test. ExecuteNow( ) may or may not generate a Notify event.

c) Poll( )—returns to the caller a list of attributes and values. The values returned when Pollo is called against a Dynamic Bean (FIG. 9 1.2) are the last values from the last Execute( ). In other words, Poll( ) just displays the most recent values associated with a test, it does not execute the test. Poll( ) is used to re-synchronize the Manager(s) with the actual values—which are stored at the Managed Node in the preferred embodiment (but need not be in alternate embodiments). When Poll( ) is executed against a Control Bean, it returns the name and arguments to the tests that are configured for each attribute.

d) Reset( )—reset informs a Dynamic Bean to re-read the Bean config file (FIG. 9 2.3) and update the in-core control list. The in-core control list is a memory version of the Bean config file. A reset( ) against the Control Bean, re-reads the Bean config file—resetting the Control Bean back to its last saved state.

e) Save( )—Save against the Dynamic Bean saves the name and value of attributes to disk, so that when the Dynamic Bean restarts it returns to it last known state. The values of attributes are thereby saved across instantiations of the Dynamic Bean, without the need to re-run the tests each time the Dynamic Bean starts. Save executed against the Control Bean saves the in-core version of attributes and tests to the Bean config file (FIG. 9 2.1).

Scheduler

A Scheduler runs on the Managed Node (FIG. 2—2.0, 7.0) which has been pre-programmed from either the Manager (FIG. 3—3.2) or locally (FIG. 3—4.0) on the Managed Node (or Gateway). The Scheduler contains a schedule of specific Attribute tests, to be invoked on one of the Beans (FIG. 2—1.0, 3.0, 4.0, 6.0) via the Execute method of the Bean. The Scheduler invokes these tests automatically when the schedule conditions (e.g. hourly, monthly, every day at 5 PM etc) are detected. Herein, the Scheduler is implemented as a Dynamic Bean (with Control Bean). Scheduler can be implemented as a simple Bean or a custom code, or an external Scheduler (e.g. Cron or At) can be used.

Archive Object

Data on a Managed Node is archived by the Archive Object. It keeps multiple iterations of change, which are typically stored on the Managed Nodes. Archive data can be stored anywhere, Manger, Managed Node, and a separate node like a file server. The Archive Object supports simultaneous methodologies: 1) maintaining generations of changes and 2) maintaining data in a minimum amount of disk storage. When a Simple or Dynamic bean executes a test, it (the Bean) stores the output from the test into the Archive Object. The Archive Object supports methods to insert and extract data. The Archive Object also supports the ability to compare any two generations of the archive using the Diff( ) method. Simple and Dynamic Beans use this Diff( ) method to detect changes. If changes are detected by the Diff( ), the Bean knows to generate a change notification to all Managers.

The Diff( ) method of the archive performs complex change notifications, based upon configuration compare criteria disclosed in the Attribute Transformation Criteria section below.

Attribute Tests

The name of the attribute test that is scheduled may be the same name as the Attribute. The name of the test and the name of the Attribute can be differencet. For example, Attribute:SHMMAX=2500; Test:SHMMAX_TEST=“grep SHMMAX/etc/system”. When the attribute test is invoked, a Simple or Dynamic Bean runs the test and the test fills the value of the attribute. For example, an attribute test might be scheduled and be named “memory”. When invoked by the Scheduler, the Dynamic Bean looks up the test in an “in-core: a control list searching for the attribute name (e.g. memory), once found, it associates the attribute name (e.g. memory) with the function to execute which will populate the attribute (e.g. getmemory). The return from the test (e.g. getmemory returns 512), would populate the Dynamic Bean's memory attribute with a value (e.g. memory=512 MB).

When in FIG. 2, the execute method (FIG. 2—1.0) is called, it performs local work writing the output (FIG. 2—1.2) of the test to the archive log (FIG. 2—1.3) which is usually local to the Managed Node with the agent (FIG. 2—A. 1. The execute( ) and executeNow( ) exposed interfaces not only run the test specified, but also detect if the output from the test is different from previous executions. It does this using the Diff( ) method of the Archive Object. If the output from the test is different from previous outputs, the Simple or Dynamic Bean may generate a change notify event and forwarded to the Event Handler (FIG. 2—5.0) on the Manager Node (FIG. 2—A.2).

Attribute tests can be defined with a scope parameter, such as Global, Local or Metric scope. This scope parameter is used to in node comparison reports as a filter to limit the results to attributes of the same scope. For example, attributes with the Global scope are the types of attributes one would synchronize across a technology infrastructure, such as a kernel tunable parameter. Attributes with a Local scope are the types of attributes that one might compare to the same node at a previous point in time, such as the node's Internet Address. Attributes of a Metric scope are numbers, which would be graphed.

Extending Java JMX

Java JMX defines a system and method to manage Java Applications. This invention extends the concept of JMX beyond Java, providing a bridge to manage non-Java applications. This is accomplished using two exemplary techniques, such as the following:

1) The Simple or Dynamic Bean (FIG. 2—3.0) invokes a system (non-Java) command written in languages like ( FIG. 2—3.2) like Shell, Perl, Nawk, C, C++etc, to perform a test, and returns the results (FIG. 2 3.1) to the Bean. This mechanism now allows the Java programs (or programs written in one language or framework) to manage applications in a different framework.

2) The Bean uses pipes (FIG. 2-4 1.) to send commands to a system command interpreter or interactive process (FIG. 2—4.2). This mechanism now allows the Java programs (or programs written in one language or framework) to manage interactive applications in a different framework.

Note that the Java JMX framework does disclose that adapters may be used to bridge from Java JMX to non-Java interfaces (e.g. SNMP, HTTP etc). The forgoing techniques above can also be used to write more robust and easier JMX adapters. For example, using the system and method disclosed here, a JMX Adapter can be written to manage the database manager's interactive configuration utility (e.g. Oracle SQLDBA Task), extending JMX to manage a database. At the same time, this invention provides a way to manage a non-Java application or system without the need for a JMX Adapter.

Gateways

Agents can be configured to run on a node independent from the Managed Node, whereby SNMP, Telnet, FTP, HTTP, Secure Shell or some other network interconnection software is used to bridge between the agent and the agentless managed device. In this configuration, the Manager (FIG. 2—A.2) communicates with the Gateway (FIG. 2—A.3) Agent, to communicate with an agentless device. Gateways also extend the Java/JMX framework to communicate through a Firewall, by allowing the Gateway to tunnel via an opened protocol through a Firewall. Gateways can additionally allow remote management by leveraging existing VPN solutions or implementations of Secure Shell , Telnet, FTP or any remote management solution, extending the reach of the Manager, to manage nodes agentless nodes anywhere, with any protocol.

New Data Warehouse Architecture

An additional aspect of the present solution further provides for a novel technique for building a corporate data warehouse architecture. Typically, data warehouses contain data from multiple feeder systems, where ETL (Extract, Transform and Load) mechanisms are used to reformat the data into a corporate data warehouse data model, which is used to manage the business. The data warehouse architectures are centralized, storing copies of business data into these large centralized data warehouses. They sometimes feed all or part of their data to operational data stores or data marts for processing.

The Archive Object of the present solution archives data at the Managed Node. That data need not be only change data, it can be any data that an organization needs to store to make business decisions. The database on the Manager need not only store changes, it can be a considered a “data mart” or “operational data store” and the Archive Objects, all acting in unison can be considered a “data warehouse”.

This invention's Archive Object and framework can be used to build a data warehouse that stores the data warehouse distributed among all the Managed Nodes or Gateways in a compute infrastructure. Rather then moving data from the Managed Nodes to a central warehouse, disk space on the Managed Nodes is utilized to build a data warehouse, which is used as the data warehouse for the organization. The extract methods of the Agent, allow copies of this highly distributed data warehouse to be fed to operational data stores or data marts. Highly distributes queries against the archive are supported by distributing the queries out to every agent, via an enhanced set of exposed interfaces to the Beans (e.g. SQL Syntax, ListPull, Extract).

### Manager

Manager

A Manager contains both a GUI and the business logic to support management functions. In an alternate embodiment, theGUI can be separated from the Manager. The Manager provides the graphical interface to aspects and features of the present solution. Multiple Managers can be inter-connected using Manager Beans, which are special purpose Beans that make a Manager look to another Manager as an Agent. In an alternate embodiment, Manager Beans act as proxy agents, proxying all the activity (e.g. Nofify events) from the agents primary Manager, to another secondary Manager(s), and allowing also the secondary Manager(s) to send requests via the same Manager Beans via the same proxy mechanism. Multiple Managers can share a single database, or multiple Managers can each have their own independent database.

Attribute Transformation Criteria

Attribute transformation criteria allows more complex comparisons between baseline values and target values. This is accomplished using a Transform function in the baseline attribute. In an alternate embodiment, attribute transform functions can be implemented on target attributes as well. The baseline (FIG. 6—1.0) also illustrates that a lists of baseline attributes contain a plurality of transform functions used for attribute matching criteria including, but not limited to:

1) Attribute should equal baseline, represented using the syntax in Attribute-C in (FIG. 6—1.0)

2) Attribute should not exceed baseline (threshold), represented using the syntax Attribute-B in (FIG. 6—1.0) 50.le—interpreted as target attribute should be less then or equal to 50.

3) Attribute should land within a range of values specified in baseline (range), represented using the syntax Attribute-A in (FIG. 6 1.0).—interpreted as target attribute should be greater than or equal to 25 and less then 50.

4) System contains a complete list of operators for the compare-(e.g.: .le, gt, (And), | Or, if, While etc) The list of attribute compare criteria is programmable, which allows flexible, extensible and complex comparisons.

Comparisons can also include multi-attribute aggregation, which allows for a correlation of compares between multiple target attributes coming from multiple nodes against a complex rules. This is represented in Attribute-E (FIG. 6—1.0), whereby a Correlation Object is specified along with arguments (rules in this example).

Attribute Transformation Criteria can be used both at the Manager for reporting and display and at the Managed Node for detecting changes.

Database Updates

This section describes a method of routing changes to database tables based upon the contents of a change notification message or event.

Databases are located on the Managers, and change data is archived on the Managed Node. The source for Attribute data comes from the archive and the source for Dynamic Bean configuration data is stored on the Managed Node(s), a) Attribute and Beansconfig. Data can be sourced from the Manager as well, b) or shared between the node and the Manager, c) or from another node or external data source not specified here. Copies of this data (archive/Bean config) exist on database tables in Managers. Updates to the Dynamic Bean's configuration are stored on the Managed Node(s) into the Bean config file using the Control Bean. When updates to the Bean config file occur, a notification event is sent from the Control Bean to the Manager(s), who update their database tables to reflect the change. When a test is executed on a Bean (Simple or Dynamic), if a change is detected, the Bean triggers a change notification to the Manager(s), who update their tables to reflect the change.

The Manager (s) can go to the Managed Node(s), execute the Poll( ) function of each Simple or Dynamic Bean and use the results to update their database copies (in alternative embodiments of the present solution all data is stored in either the archive, the centralized database, or a combination of the two. The location of where data is stored, if it is stored in a database or archive, is variable and flexible, although in the preferred embodiment, data is sourced at the archive, and maintained current at the Manager using the Poll and Notify mechnisms disclosed) of with the data received from the Poll functions. For example, FIG. 9—1.2 shows how a Poll( ) function against a Dynamic or Simple Bean returns the value of the attribute. Since the valid source for data is the Managed Node(s), the Manager making this Poll( ) request can use the output from the poll to update its database tables, writing what was returned from the Pollo as the most current values. Similarly, a Poll( ) of the control Bean indicates the valid configuration of tests, and Managers who poll the Control Bean can update their tables to reflect the value returned from Poll( ) as the most current.

In one embodiment, the present solution only transmits changes to attribute values to the Manager(s). This is accomplished via change notification mechanism. FIG. 2 illustrates how the Notification mechanism of this invention keeps the database on the Manager(s) in-sync with the attributes and Bean config data. The notification back to the database can come by means of a proxy, such s an http proxy. The Managed Node with Agent (FIG. 2—A.1) or Gateway functionality (FIG. 2—A.3) sends Change Notify Events to the Event Notify Handler (FIG. 2—5.0) in the Manager(s) (FIG. 2—A.2). The contents of these messages (FIG. 2—5.1, 5.2, 5.3, 5.4) contain information that allows the Event Notify Handler (FIG. 2—5.0) to route the messages (FIG. 2—2.4-a, 2.4-b, 2.4-c) to the appropriate database tables (FIG. 2—2.5-a, 2.5-b, 2.5-c). Note that the process is normally asynchronous (non-blocking), but can be synchronous as well (Management Dynamic Bean (FIG. 2—1,0, 3.0, 4.0 6.0) blocks or waits until database update is complete). The Scheduler (FIG. 2—2.0, 7.0) having previously been configured to schedule work, runs the execute method (FIG. 2—2.1, 2.2, 2.3, FIG. 2—7.1) with the previously scheduled test. The Execute Method is one of several exposed interfaces to the Dynamic Bean (FIG. 2—1.0, 3.0, 4.0 and 6.0). The execute( ) method of the Dynamic Bean runs the test, the process of running the test detection of the change occurs, resulting in a change notify event to the Manager.

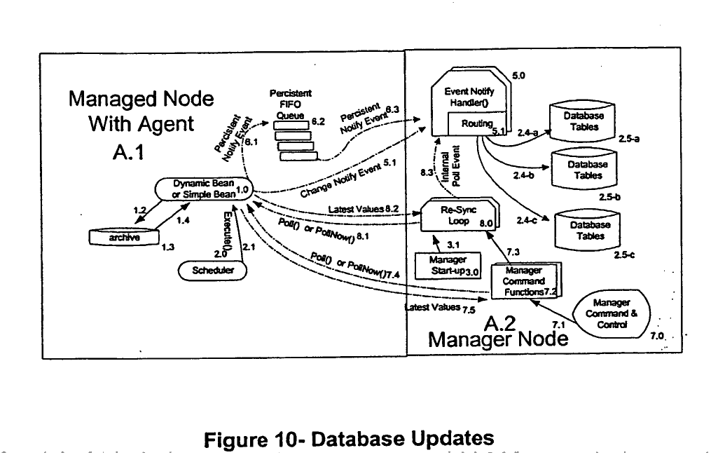

FIG. 10 illustrates the Change Notification Process again—Scheduler 2.0, Execute 2.1, Bean 1.0, Change Notify Event 5.1, however FIG. 10 further shows that the Event Hander 5.0 uses a routing function 5.1 to send database changes 2.4-x to the appropriate tables 2.5-x.

FIG. 10 also illustrates a Persistent Notification Mechanism (6.1, 6.2 and 6.3) of the present invention, which utilizes a persistent FIFO queue to store messages. FIFO (FIG. 10 6.2) need not be persistent (i.e. sotred on disk). FIFO (FIG. 10 6.2) need not be on the Managed Node.

FIG. 10 further illustrates that a Polling mechanism 8.x is used in conjunction with the Notification mechanism 5.x. The Manager start-up routines initiate the start of a thread that performs polling of the Beans on behalf of the Manager referred to on FIG. 10 as the re-sync loop 8.0. Re-Sync (FIG. 10 8.0) is shown here as a single object/thread, in an alternate embodiment Re-sync can be distributed to the. many management functions (FIG. 10—7.2) that may require polling. As implied by this name, Polling is generally used to re-sync the database with the Beans, although that is not Polling's only purpose. The Manager startup (FIG. 10 3.0), Command and Control (FIG. 10—7.0), internal Manager functions (FIG. 10—7.2) may initiate polling or a single poll of one or more Beans. The two types of Polling's exposed in this invention are the standard Poll, which takes the latest values and a PollNow( ) function which forces the Bean to execute a test and may also take the results of that test. There are two forms of PollNow( )—PollNow returning the data to the Management function and PollNow returning the data via one of the Notification Mechanisms (FIG. 10 5.1 or 6.1).

FIG. 10 also illustrates that Poll or PollNow( ) (7.4-7.5) can be executed by a command function (7.2). A command function is any finction within the Manager that for the purpose of implementation requires data directly from the Bean. Command finctions can typically go to the database to determine recent values of attributes. Or command functions can go directly to the Bean using the Polling functions (FIG. 10 7.4, 7.5). Of command finctions can go to the Re-sync loop (FIG. 10 8.0) to initiate an update to the database, then read the update from the database.

### Reporting and Grouping

This section discloses reporting constructs that are critical to the ability to manage changes on a plurality of compute nodes on a diverse network.

Multi-Line Configuration

Some display and reports are multi-line FIG. 8 illustrates a drill-down (FIG. 8 5.0) function that allows details to be encapsulated into a digital signature (e.g. checksum) at the immediate results level (FIG. 8 3.1) and a drill-down to more details at FIG. 8 5.0.

System Compare Against a Baseline Node

This invention provides methods of detecting and reporting changes within compute infrastructure. The Baseline can be any selected attributes with a unique name as a reference (e.g. Build22), or any group of attributes taken from any node at a point in time. FIG. 5 illustrates the cross system compare against a baseline node (FIG. 5—1.0), whereby the baseline (FIG. 5—1.0) and targets nodes (FIG. 5—2.0, 3.0 and 4.0) are selected, then compared (FIG. 5—7.0) to produce results. The results can be a report or an interactive display with drill-down to details. This invention can use a single node (FIG. 5—1.0) (physical or logical, hardware or software) as a baseline from which to compare (FIG. 5—7.0) multiple target nodes (FIG. 5—2.0, 3.0, 4.0) to produce cross system compare results (FIG. 5—1.1). The results show the differences in configuration between attributes on the nodes, including but not limited to, for example:
One of the file-servers in a group is considered the most recent with respect to software patches, compare it to the selected or targeted file-servers to know which of the target file-servers require software patch upgrades.
   Attributes (FIG. 5—1.3) from the baseline node (FIG. 5—1.0) are fed into the compare function (FIG. 5—7.0) and compared against attributes (FIG. 5—2.2, 3.2, 4.2) from the target nodes (FIG. 5—2.0, 3.0, and 4.0).
   System Compare Against a Node-Group A Node Group can be any arbitrary grouping of nodes assigned to a unique name (e.g. Web Servers), or any list of selected nodes.

Refer now to FIG. 6. FIG. 6 illustrates the cross system compare of a baseline (FIG. 6—1.0) against a group node (FIG. 6—5.0), whereby the baseline (FIG. 6—1.0) is not a physical node, rather it is a list of attributes (FIG. 6—1.0) that are expected on the target nodes (FIG. 6—2.0, 3.0 and 4.0). The Node-Group (FIG. 6—5.0) illustrates that groups of target nodes (FIG. 6—2.0, 3.0, and 4.0) can captured and labeled as a group, to be selected as such for reporting. This grouping is usually done before reporting, and saved into a meaningful name (e.g Node-Group I in FIG. 6 5.0). For example, a group of web servers might require the same attribute settings, so they can be managed together in a single group named web-group. Rather then individually select targets nodes (FIG. 6—2.0, 3.0 and 4.0), the Node-Group FIG. 6—5.0 is selected for reporting. This can be used to produce a report or populate an interactive display. The concept is that a baseline list of attributes (FIG. 6—1.0) can be used as master copy from which to compare (FIG. 6—7.0) multiple target nodes in a group (FIG. 6—5.0) or individually selected (FIG. 6—4.0). The Node-Group (FIG. 6—5.0) concept simplifies the selection and management of groups of target nodes (FIG. 6—4.0, 3.0), by allowing the selection to saved as a group, with its own unique name. Attributes (FIG. 6—1.3) from the baseline node (FIG. 6—1.0) are fed into the compare function (FIG. 6—7.0) and compared against attributes (FIG. 6—2.2, 3.2, 5.2) on the target nodes (FIG. 6—2.0, 3.0, and 4.0). The results (FIG. 6—1.1) of the compare contain the original baseline list of attributes (FIG. 6—1.2) and lists of target attributes (FIG. 6—2.1, 3.1, 4.1) that match criteria like Attribute should match baseline, Attribute should land within a range of values specified in baseline etc. The list of attribute compare criteria is programmable, which allows flexible comparisons (see Attribute Transformation Criteria for disclosure). One key claim is that Node groups can contain nodes or other node groups (FIG. 6—5.3), or combinations of both (FIG. 6—5.0). This claim is critical when is comes to display and interaction of very large numbers of nodes.

Cross Attribute Compare Against Nodes and/or Node-Groups

To compare and contrast change in a compute infrastructure allows the environment to be simplified, by minimizing the variability within nodes.

FIG. 7 illustrates the cross attribute compare of a baseline against a node (FIG. 7—2.0) or group node (FIG. 7—5.0) and Node (FIG. 7—2.0), whereby the baseline (FIG. 7—1.0) is not a physical node, rather it is a list of attribute groups (FIG. 7—1.7). Attribute groups (FIG. 7—1.1, 1.6) are containers for lists of attributes (FIG. 7—1.4, 1.5). The user can select these groups, rather then selecting baselines (FIG. 5, FIG. 6). The advantage of attribute grouping is that a subset of attributes associated with a node can be used to compare as a baseline across a population of target nodes. For example, the TCP/IP settings in an Attribute group named “TCP-CONFIG” might be used to compare the TCP settings on every node on the network. When reporting using an attribute group, the user selects the group (FIG. 7—1.7), which is in reality the list of attributes contained in the group (FIG. 7—1.4). These are fed (FIG. 7—1.3) to the compare (FIG. 7—7.0) function. The target nodes might be individually selected (FIG. 7—2.0) or they may be selected using a node group (FIG. 7—5.0). The compare function (FIG. 7—7.0) takes feeds from the target nodes (FIG. 7—2.1) or node groups (FIG. 7—5.1). The node groups (FIG. 7—5.0), receive their values from the nodes (FIG. 7—3.1 and 4.1). FIG. 7 illustrates, that attributes can be grouped (FIG. 7—1.7 containing 1.4, 1.6 containing 1.5). FIG. 7 illustrates that a mix of nodes (FIG. 7—2.0) and node groups (FIG. 7—5.0) can be used for reporting. The Node-Group (FIG. 7—5.0) contain target nodes (3.0, and 4.0) can be captured and labeled as a group, to be selected as such for reporting. This grouping is usually done before reporting, and saved into a meaningful name (node-Group II). For example, a group of routers servers might require the same configuration settings, so they can be managed together in a single group named router-group. Rather then individually select targets nodes (FIG. 7—2.0, 3.0 and 4.0), the Node-Group (FIG. 7—5.0) is selected for reporting; which is mixed with real nodes (FIG. 7—2.0). The results of the compare (FIG. 7—7.0) can be a report or an interactive display. The concept is that a baseline might consist of groups (FIG. 7—1.7, 1.6) of attributes (FIG. 7—1.4,1.5) (physical or logical, hardware or software) can be used as a baseline from which to compare (FIG. 7—7.0) multiple target nodes (FIG. 7—2.0, 3.0, 4.0). The Node-Group (FIG. 7—5.0) simplifies the selection of groups of target nodes, by allowing the selection to saved as a group, with its own unique name. Attributes (FIG. 7—1.3) from the baseline node (FIG. 7—1.0) are fed into the compare function (FIG. 7—7.0) and compared against attributes (FIG. 7—3.2, 4.2) on the target nodes (FIG. 7—2.0, 3.0, and 4.0). The results (FIG. 7—1.1) of the compare contain the original baseline list of attributes (FIG. 7—1.2) and lists of target attributes (FIG. 7—2.1, 3.1, (FIG. 7—4.1) that match criteria like Attribute should match baseline, Attribute should land within a range of values specified in baseline etc. The list of attribute compare criteria is programmable, which allows flexible comparisons. FIG. 7 1.6 Attribute-Group-Y contains is an Attribute group, which contains both Attributes and another Attribute Group.

Results (FIG. 7—see 1.1. in FIG. 5,6 and 7) are the output of a compare function that allows multiple groupings or individual selections of attributes, groups or attributes, nodes or groups of nodes, or mixed variations of the above selections.

Attribute Grouping and Aggregation

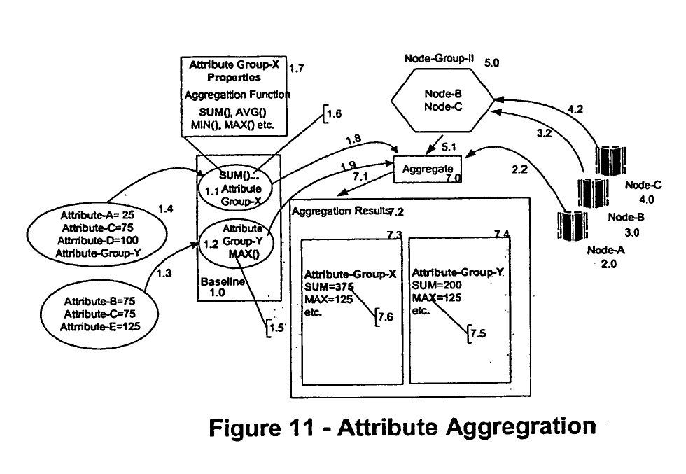

FIG. 11 and the previous section illustrate Attributes groups (FIG. 11—1.1 & 1.2) for reporting and display purposes. This invention also discloses that Attribute groups can contain a plurality of aggregation functions (FIG. 11—1.7). These are functions that apply to Attributes within a group (FIG. 11—1.1 & 1.2). Illustrated in FIG. 11—7.4, the aggregation functions 1.6 and 1.5 are computed (FIG. 11—7.0) when the values of the attributes are referenced as part of a display or report. The results are thereby displayed (FIG. 11—7.2) as properties of the attribute group. Individual properties (FIG. 11—1.5 & 1.6) may be displayed (FIG. 11—7.5 and 7.6). Aggregation functions are useful for computing, then displaying for example, the number of users in a site, whereby the aggregation function is counting the attribute such as the number of users on each node, and all those per node attributes are contained in a single attribute group. When that attribute group is referenced, one of its properties might be the SUM property, containing the aggregation.

In situations whereby the root Attribute Groups contains other Attribute groups (FIG. 11—1.4) or even groups of groups or groups, the leaf node attributes are aggregated for all the leaf nodes in the tree as illustrated by example in FIG. 11—7.3). A list of Attribute aggregation fuictions that can be individually assigned to a list of contained attributes is also disclosed. This allows individual attributes (leaf nodes) to be used to populate the an aggregation list, while ignoring other leaf nodes. This also allows aggregation of branch nodes, including or excluding leaf nodes.

Attribute Transform Functions and Attribute Aggregation Functions

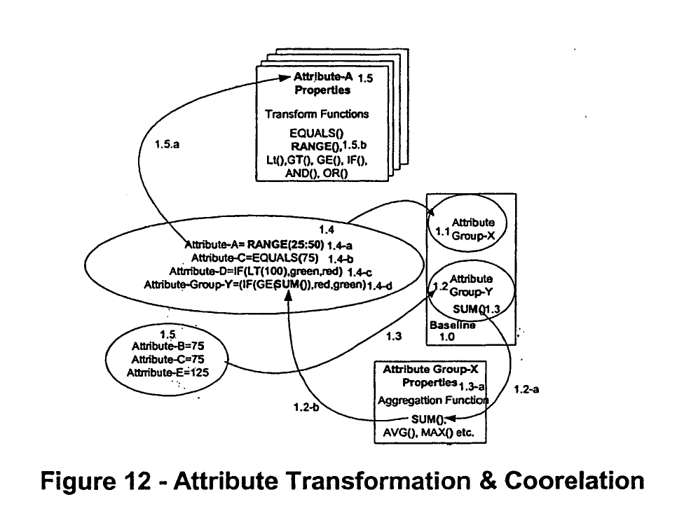

As disclosed above in the Attribute Transformation Criteria section, Attributes can contain transform functions to implement more complex comparisons across attributes This is also illustrated in FIG. 12. A specific attribute (FIG. 12—1.4a) contains a transform function (e.g. RANGE( )), which may be used to compare this attribute against a list of target attributes. FIG. 12 illustrates that the transform functions can be multiple and varied, with operators like RANGE, IF, GT etc. It can return a value (FIG. 12—1.4-b) or a status (FIG. 12—1.4-c, 1.4-d).

Attributes groups can also have Transform functions (FIG. 12—1.4-d). Attribute groups contain Aggregation functions (FIG. 12—1.3, 1.3a) (Section Attribute Grouping and Aggregation) and these aggregation functions can be referenced in an attribute transformation (FIG. 12—1.2a, 1.2b). This is useful for combining Attributes Aggregations and Transformations into a single value or status.

Extending Transform and Aggregation Functions

The combination of robust attributes transform functions and robust Aggregation Functions allows for cross correlation between attributes without the need to develop programs. However, if an attribute Transform Function or object is referenced that is not currently defined as part of this invention, it is first looked for as an internal function or object within this system. If it is not found as an internal object, it calls an external command script to evaluate the transform function of aggregation function. In this manner, this invention is extended to include new and more robust transform and aggregation functions including the ability to write custom functions in other languages and interface into this invention via a command script execution.

### CONCLUSION

Having now described several embodiments of the present invention, it should be apparent to those skilled in the art that the foregoing is illustrative only and not limiting, having been presented by way of example only. All the features disclosed in this specification (including any accompanying claims, abstract, and drawings) may be replaced by alternative features serving the same purpose, and equivalents or similar purpose, unless expressly stated otherwise. Therefore, numerous other embodiments of the modifications thereof are contemplated as falling within the scope of the present invention as defined by the appended claims and equivalents thereto.

For example, the techniques described herein may be implemented in hardware or software, or a combination of the two. Moreover, the techniques may be implemented in control programs executing on programmable devices that each include at least a processor and a storage medium readable by the processor (including volatile and non-volatile memory and/or storage elements). Each such control program is may be implemented in a high level procedural or object oriented programming language to communicate with a computer system, however, the programs can be implemented in assembly or machine language, if desired. Each such control program may be stored on a storage medium or device (e.g., CD-ROM, hard disk or magnetic diskette) that is readable by a general or special purpose programmable computer for-configuring and operating the computer when the storage medium or device is read by the computer to perform the procedures described in this document. Furthermore, the techniques described herein may also be implemented as a computer-readable storage medium, configured with a computer program, where the storage medium so configured causes a computer to operate in a specific and predefined manner.

1. In a network having a plurality of nodes having related attributes, a computer-implemented method of detecting and reporting unauthorized changes within said network, comprising:
providing a baseline node having predefined baseline attributes associated therewith;
selecting at least one target node having target attributes associated therewith;
comparing said baseline attributes with said target attributes;
generating a display comprising drill down details of said comparison results and said baseline and target attributes.

2. The method as in claim 1 further comprising: encapsulating said comparison results and generating a display comprising drill down details of said encapsulated comparison results and said baseline and target attributes;

3. In a network having a plurality of nodes having related attributes, a computer-implemented method of detecting and reporting unauthorized changes within said network, comprising the steps of:
providing a set of predefined baseline attributes;
selecting a group of target nodes, each group member having target attributes associated therewith;
comparing said set of predefined baseline attributes with said target attributes of said group members to detect change; and
generating a display comprising drill down details of said comparison results and said baseline and target attributes.

4. The method as in 3 wherein said generating step further comprises: encapsulating said comparison results and generating an interactive display comprising drill down details of said encapsulated comparison results and said baseline and target attributes.

5. The method as in 3 wherein the target node group comprises at least one target node, subgroups of target nodes or a combination thereof.

6. In a network having a plurality of nodes having related attributes, a computer-implemented method of detecting and reporting unauthorized changes within said network, comprising the steps of:
providing a group of baseline attributes;
selecting a target node having target attributes associated therewith;
comparing said group of baseline attributes with said target attributes to detect change; and
generating a display comprising drill down details of said comparison results and said baseline and target attributes.

7. The method as in 6 wherein said generating step further comprises the step of: encapsulating said comparison results and generating an interactive display comprising drill down details of said comparison results and said baseline and target attributes.

8. The method as in 6 wherein said target node comprises at least one target node, subgroups of target nodes or a combination thereof.

9. The method as in 6 wherein said baseline attributes group comprises a set of baseline attributes, at least one subgroup of baseline attributes, or a combination thereof.

10. In a network having a plurality of nodes having related attributes, a computer-implemented method of detecting and reporting authorized changes within said network, comprising:
providing a baseline attribute having an attribute transformation function;
selecting a target node having a target attribute;
comparing said attribute transformation function with said target attribute to detect change; and
generating a display comprising drill down details of said comparison results and said baseline and target attributes.

11. The method as in 10 wherein said generating step further comprises the step of: encapsulating said comparison results and generating an interactive display comprising drill down details of said comparison results and said baseline and target attributes.

12. The method as in claim 10 further comprising the steps of:
providing an attribute group having an aggregation function; and
associating said attribute transformation function with said attribute group,
wherein said attribute transformation function references said aggregation function thereby combining said aggregation function and said transform function into a single value for comparison and reporting purposes.

13. In a network having a plurality of nodes having associated node attributes, a computer-implemented method of detecting and reporting unauthorized changes within said network, said method comprising:
providing a manager node having predefined baseline attributes for use in detecting changes to said node attributes;
providing a node having node attributes to be managed by said manager node;
providing a database associated with said manager node for storing node attribute change information;
said manager node: 1) polling said node attributes to detect differences between said baseline attributes and said node attributes; and 2) updating said database with data relating to reflect said detected differences.

14. The method as in claim 13 further comprising the step of reporting information related to said detected differences.

15. The method as in claim 14 wherein the reporting step further comprises the step of: genera ting an interactive display comprising drill down details of said detected differences.

16. The method as in claim 13 wherein said node has an agent associated therewith, said agent comprises a control bean and a dynamic bean; said manager updates said control bean with said predefined baseline attributes.

17. In a computer-implemented network comprising a plurality of agentless nodes, a method for managing change events occurring within said network and initiated by said plurality of agentless nodes, said method comprising:
providing an agentless node;
providing a manager node for managing said agentless node, and
providing a gateway node situated between said manager node and said agentless node; said gateway node configured to interface with said manager node and said agentless node to provide a bridge therebetween to enable said agentless node to notify said manager node of a change event affecting said agentless node.

18. A method as in claim 17, wherein said manager node also comprises a database for storing said agentless node change event information.

19. A method as in 18, further comprising the step of reporting said agentless node change event information.

20. The method as in claim 19 wherein said reporting step further comprises the step of: encapsulating said agentless node change event information and generating an interactive display comprising drill down details of said agentless node change event information.

21. The method as in 20, wherein said agentless node change event information is encapsulated into a digital check sum.

22. In a computer network having a plurality of nodes comprising one or more attributes having associated attribute tests, a method for scheduling the execution of said attribute tests to manage change events within said network, said method comprising:
providing an attribute test having a trigger condition associated therewith;
monitoring said network to detect said trigger condition; and
automatically executing said attribute test in response to said trigger condition.

23. A computer-readable medium having stored thereon an archive object data structure for use in a computer-implemented network comprising a plurality of nodes, said archive object data structure to store information relating to change events occurring within said network, said archive object data structure comprising:
an archive field containing data representing node state information; and
a first interface that receives and stores said node state information in said archive field,
a second interface that extracts said stored node state information from said archive field, and
a comparison behavior that compares incoming node state information with stored node state information to detect change events occurring within said network.

24. In a JAVA JMX network having a plurality of nodes, a method for extending the Java JMX framework to manage non-Java applications without utilizing a JMX adapter, said method comprising:
providing a non-Java application to be managed;
providing a Java management bean object for managing said non-Java application;
said Java management bean object, 1) invoking a non-Java system command to perform a predefined test having predefined parameters associated with said non-Java application; 2) processing and reporting the results of said non-Java system command invocation;
wherein said Java management bean object comprises:
a first bean field containing data representing said results of said non-Java system command invocation,
a second bean field containing predefined benchmark data,
a first exposed bean interface to receive incoming non-Java system command invocation results information,
a second exposed bean interface to invoke said non-Java system command;
a first bean behavior to store said non-Java system command invocation results information in said command results field,
a second bean behavior to compare said incoming non-Java system command invocation information with said stored non-Java system command invocation information to detect and report changes therebetween, and
a third bean behavior to trigger an alert notification when said non-Java system command invocation information comparison results deviate from said predefined benchmark data.

25. A method as in claim 24 wherein said bean object is simple or dynamic.

26. A method as in claim 24 wherein said invoking step is done interactively or via a schedule.

27. In a JAVA JMX network embodying the Java JMX framework, a method for extending said Java JMX framework without utilizing a JMX adapter to manage a non-Java application executing within said network, said method comprising:
providing a system command interpreter for interpreting a non-Java system command invoked by said non-Java application into a Java JMX command; and
providing a Java bean object having a pipe coupled to said system command interpreter, said Java bean object for sending said non-Java system command to said system command interpreter via said pipe.

28. In a computer-implemented network having a plurality of nodes, a method for providing a data warehouse to store network information relating to interactions among said nodes, said method comprising the steps of:
providing target nodes;
providing manager nodes for managing said target nodes;
providing a database associated with said target and manager nodes to store information relating to the interaction among said manager nodes and said target nodes;
providing archive objects associated with said manager nodes, said archive objects to store information relating to the interaction among said manager nodes and said target nodes; and
determining and distributing said manager-target node interaction information between said archive objects and said database.

29. A method as in claim 28, further comprising retrieving and aggregating said archive object's manager-target node interaction information and reporting said aggregated information.
